(19) United States
(12) Patent Application Publication
(10) Pub. No.: US 2018/0272670 A1
(43) Pub. Date: Sep. 27, 2018

(54) PRINTABLE COATINGS FOR FILMS AND LABELS

(71) Applicant: Jindal Films Americas LLC, LaGrange, GA (US)

(72) Inventors: David Piran, Norbressart (BE); William Grisard, Marville (FR)

(73) Assignee: Jindal Films Americas LLC, LaGrange, GA (US)

(21) Appl. No.: 15/983,134

(22) Filed: May 18, 2018

Related U.S. Application Data
(63) Continuation of application No. PCT/US16/68126, filed on Dec. 21, 2016.
(60) Provisional application No. 62/270,370, filed on Dec. 21, 2015.

(51) Int. Cl. B32B 27/08; B32B 27/32; B32B 27/36; B29C 47/00; B29C 55/14; B29C 47/06

(52) U.S. Cl. CPC B32B 27/08; B29K 2023/12; B32B 27/36; B29C 47/0004; B29C 47/0021; B29C 47/0057; B29C 55/143; B29C 47/065; B29C 47/0069; B32B 2255/10; B32B 2255/26; B32B 2264/102; B32B 2307/41; B32B 2307/518; B32B 2307/5825; B32B 2307/746; B32B 27/32

(57) ABSTRACT

Disclosed are methods, compositions and structures that, in one example embodiment, is a film that includes a multilayered base film comprising a core and at least one printable coating applied to at least one outer surface of the multi-layered film. The at least one printable coating may include an acrylic-based polymer, and have a dry coating weight is within a range from 0.1 g/m² through 0.9 g/m² with a pH of at least 9. The film complies with European regulations for use in food-contact packaging and labeling, which are examples of applications for the disclosed films.

### REFERENCE TO RELATED APPLICATIONS

The present application is continuation of and claims priority to a Patent Cooperation Treaty (PCT) application serial number PCT/US16/68126 filed on Dec. 21, 2016 that claims priority to United States provisional patent application Ser. No. 62/270,370 filed Dec. 21, 2015, wherein the foregoing applications are hereby incorporated by this reference in their entireties.

### FIELD

The disclosure relates to printable coatings on co-extruded, multilayered films, processes applied thereto, products made therefrom such as bags, tags, packages, labels, including pressure-sensitive labels (“PSLs”), and other structures, and uses thereof, such as to wrap, package, contain or label foods, beverages, and other articles or products. The disclosure also relates to printable, two-sided, coated polymer-based films and labels that are resistant to blocking while providing robust adherence to adhesives and resistance to moisture.

### BACKGROUND

Countries and jurisdictions sometimes impose regulations on films and labels that are used in food-contact applications. Accordingly, some PSL films may not be acceptable for food contact. Nevertheless, if the food-contact films, such as those made into films, comply with food-contact regulations, then embodiments of the films should also provide printability, resistance to blocking, robust adhesive to adhesives and/or resistance to moisture and oxygen. These are examples of objectives attainable through the disclosed compositions, methods, and uses in the instant disclosure.

### SUMMARY

Disclosed are methods, compositions and structures that, in one example embodiment, is film that includes a multilayered base film comprising a core and at least one printable coating applied to at least one outer surface of the multi-layered film. The at least one printable coating may include an acrylic-based polymer, and have a dry coating weight is within a range from 0.1 g/m² through 0.9 g/m² with a pH of at least 9. The film complies with European regulations for use in food-contact packaging and labeling, which are examples of applications for the disclosed films.

### BRIEF DESCRIPTION OF THE DRAWINGS

So that the manner in which the above recited features, advantages and objects of this disclosure are attained and may be understood in detail, a more particular description, briefly summarized above, may be had by reference to the embodiments thereof which are illustrated in the appended drawings.

It is to be noted, however, that the appended drawings illustrate only typical embodiments of this disclosure and are therefore not to be considered limiting of its scope, for the disclosure may admit to other equally effective embodiments.

FIG. 1 provides a general outline of the protocol and settings used for printing trials on the pilot coater for FIGS. 2, 4A and 4B in accordance with the disclosed methods, structures, and compositions.

FIG. 2 are ink adhesion and ink density test results for white films in accordance with FIGS. 1, 4A and 4B and the disclosed methods, structures, and compositions.

FIG. 3 are ink adhesion and ink density test results for clear films in accordance with FIGS. 1, 4A and 4B and the disclosed methods, structures, and compositions.

FIG. 4A is a listing of formulations used in the white films tested in FIG. 2.

FIG. 4B is a listing of formulations used in the white films tested in FIG. 3.

FIG. 5 provides a general outline of the protocol and settings used for printing trials on the industrial coater for FIGS. 6, 8A, and 8B and in accordance with the disclosed methods, structures, and compositions.

FIG. 6 are ink adhesion and ink density test results for white films in accordance with FIGS. 5, 8A, and 8B and the disclosed methods, structures, and compositions.

FIG. 7 are ink adhesion and ink density test results for clear films in accordance with FIGS. 5, 8A, and 8B and the disclosed methods, structures, and compositions.

FIG. 8A is a listing of formulations used in the white films tested in FIG. 6.

FIG. 8B is a listing of formulations used in the clear films tested in FIG. 7.

### DETAILED DESCRIPTION

Below, directional terms, such as “above,” “below,” “upper,” “lower,” “front,” “back,” “top,” “bottom,” etc., are used for convenience in referring to the accompanying drawings. In general, “above,” “upper,” “upward,” “top,” and similar terms refer to a direction away the earth's surface, and “below,” “lower,” “downward,” “bottom,” and similar terms refer to a direction toward the earth's surface, but is meant for illustrative purposes only, and the terms are not meant to limit the disclosure.

The disclosure relates to printable coatings on co-extruded, multilayered films, processes applied thereto, products made therefrom such as bags, tags, packages, labels, including pressure-sensitive labels (“PSLs”), and other structures, and uses thereof, such as to wrap, package, contain or label foods, beverages, and other articles or products. More specifically, the disclosure also relates to printable, two-sided, coated polymer-based films and labels that are resistant to blocking while providing robust adherence to adhesives and resistance to moisture.

One focus of this disclosure is on a film's printable coating, which may be a water-based coating with enhanced printability performances with UV inks, (including, e.g., UV flexo, UV offset, UV letter press, etc.) and making the whole film's structure compliant with European and/or other countries' food-contact regulations. In one example printable coating, its composition was designed to avoid any significant blocking tendency with the backside in reel, which allows unwinding of the film/label reel to experience little or no blocking problems. Typical core and tie layers of the disclosed multilayered films may have printable coating(s) (“PC”) in structures such as PC/C/PC, PC/T/C/T/PC, PC/T/C/T/PC/S, PC/T/C/T/S, etc., wherein S is a sealant or other skin layer. The core may be any type of bi-oriented polypropylene (BOPP) films, transparent and white, with different density values inherently or according to the cavitation level (e.g., from 0.50 to 1), and optionally contain one or more additives. Besides biaxially oriented polypropylene (“BOPP”), optionally oriented homopolymers, copolymers, interpolymers, and terpolymers, wherein such polymers may vary in density, stereoregularity, method of production (e.g., catalytic or not), and other chemical and physical properties. To that end, those other polymers used as the core and/or tie layers may be polyester, polyethylene, other polyolefins, and combinations thereof and are also discussed later herein.

One objective of this disclosure was to develop a new printable structure that is compliant with food-contact requirements. Printable coatings based on an acrylic emulsion polymer, such as NeoCryl® XK90 or NeoCryl® FL780, which is an alkylphenolethoxylate (“APEO”) free version, generally shows very good printability with UV inks, but, in some cases, the printing quality is not as good as other printable coatings, e.g., cationic coatings, especially in halftone printed areas. And, the level of ink transfer during the printing process may be lower. As a result, the ink-density values after printing may be slightly lower when using NeoCryl® FL780-based coating. In some cases, such as when using more critical UV inks like low migration inks, the ink adhesion is not desirable either.

NeoCryl® FL780 XP, which is compliant with other European food regulations, was contemplated as a base for food-contact-approved coatings and film structures. NeoCryl® FL780 XP has been demonstrated and validated by DSM Neoresins and Keller & Heckman to satisfy European food regulation requirements provided that the content does not exceed the maximum authorized level.

On the other hand, acetoacetoxyethyl methacrylate (“AEEM”) is well-known to improve the ink adhesion of other printable coatings. This unsaturated monomer is sold as an adhesion promoter and has been described in some patents. See, e.g., U.S. Pat. No. 6,893,722; WO/2013112239 A1; WO/2011100029 A1.

Firstly, it was demonstrated that lower coating weights, i.e., from 0.1 to 0.3 g/m², and the addition of ammonia to the coating to increase the pH to at least 9, preferably 9 to 10, improved the ink-adhesion performances while still maintaining good printability. However, the lower coating weight seems to slightly increase the blocking tendency in reel. Despite the improved, ink-adhesion performances, the ink-transfer level, and, thereby, the ink-density values, were poorer than expected in some cases. Since AAEM is also an adhesion promoter, and was found to significantly improve the printability of other coatings, a few percent, e.g., ˜1 and ˜5 wt. %, of this AAEM was added to the NeoCryl® FL780 XP-based printable coating. Surprisingly, ink adhesion and ink densities were in line with our desires and very similar to our “non-food” contact coatings.

Experiments were carried out to evaluate the printing performances of many different printable coating formulations based on NeoCryl® FL780 XP, i.e., acrylic polymer, onto various film structures using standard cores as shown in Table 1. The films were transparent or white with various density levels. For example, one of these standard films was a white, opaque, cavitated, polypropylene film having a density in the range of 0.7-0.75 g/cm³; other standard base films that may be used include Jindal Films®'s Label-Lyte® 58SW247 surface-printable, oriented, polypropylene film (density 0.95 g/cm³) or an oriented polypropylene film (density 0.91 g/cm³). Some good printing results were observed, but, in some cases, the ink-adhesion level was not ideal when using “standard” coating weight, e.g., around 0.6 to 1.0 g/m² (typically 0.8 g/m²).

### Description of Typical/Standard Base Films

TABLE 1

| | | | |
|---|---|---|---|
| Printable | 100 PHR NeoCryl ® FL780 XP + 2 | 0.2 | g/m² |
| Coating | PHR AAEM + 0.4 PHR Sylobloc S45 | | |
| Layer | | | |
| Primer Layer | 100 PHR MICA primer | 0.004 | g/m² |
| Core Layer | BOPP Film | | |
| | Examples: 50MB210 (50 μm clear | | |
| | version), 60LH242 (60 μm white opaque | | |
| | version), or 58SW247 (58 μm solid white) | | |
| Primer Layer | 100 PHR MICA primer | 0.004 | g/m² |
| Adhesive | adhesive-receptive coating(s) | 05-1.2 | g/m² |
| Receptive | | | |
| Layer | | | |

Here, the core layer may be any kind of BOPP film that is transparent, white, opaque and solid white versions. The density range may be between 0.50 to 1 g/cm³. Preferably, the 50MB210 (transparent−density=0.91 g/cm³), 60LH242 (white opaque−density 0.72 g/cm³) and 58SW247 (solid white−density 0.95 g/cm³) are used.

The printable coating may be made from 100 parts per hundred (“PHR”) of NeoCryl® FL780 XP, 0.1 to 25 PHR AAEM, preferably from 2 to 5, and 0 to 5 PHR antiblock particles like Sylobloc S45, preferably below 1 PHR and typically 0.4 PHR. Other antiblock particles may be used such as PMMA, Teflon®, silicone particles, and/or others. The dry coating weight of the printable coating composition may be within the range from 0.05 g/m² to 2 g/m², preferably from 0.1 to 0.8 g/m² and typically around 0.2 g/m².

Pure Mica primer may be used below the printable coating and above the adhesive receptive layer as shown in Table 1. The coating weight may generally be below 0.01 g/m² and typically around 0.004 g/m². Other primer types may be used and may include polyethylene imines, polyurethanes or even NeoCryl® FL780 XP-based coatings. The presence of a primer below the printable coating is optional. The printable coating adhesion may be sufficient to provide acceptable film performances. Nevertheless, for practical and process reasons, it may be beneficial to use such kind of primer.

In the experiments that are disclosed herein, the raw materials on the printable coating side included: (1) acetoacetoxyethyl methacrylate (“AEEM”) from Sigma Aldrich (95% solids); (2) Mica primer from Mica Corporation (11.6% solids, pH 9.4); (3) NeoCryl® FL780 XP from DSM Neoresins (44% solids, pH from 8.5 to 9.0); and (4) Sylobloc 45 from Grace Davison (100% solids).

Blocking performances were measure for the disclosed films having printable coatings. The samples used to perform the following evaluation were made on a pilot equipment (pilot coater), except for the samples using “coater 50MB210” and “coater 60LH247” base films, which were coated on an industrial coater. A printable coating based on NeoCryl® FL780 with 0.4 PHR Sylobloc 45 was coated on 50MB210 base film (transparent version) and on a 60LH242 (White Opaque version) at 0.2 g/m² dry coating weight. The coating was applied directly on the corona-treated base film using no primer or a polyethylene-imine-based primer. Mica from Mica Corporation was also evaluated. Formulations with 2 and 5 PHR AAEM in the NeoCryl® FL780 XP based coating (including 0.4 phr S45) were also tested. The eight formulations tested are shown in Table 2.

TABLE 2

| | | | | Blocking AVG | Blocking max |
|---|---|---|---|---|---|
| Base film | primer | topcoat | | (g/25 mm) | (g/25 mm) |
| Pilot 50MB210 | No primer | FL780-0.4 phr S45 | No AAEM | 8.5 | 9.8 |
| Coater 50MB210 | No primer | FL780-0.4 phr S45 | No AAEM | 8.8 | 15 |
| 50MB210 | Mica | FL780-0.4 phr S45 | 2 phr AAEM | 8.9 | 11.5 |
| 50MB210 | Mica | FL780-0.4 phr S45 | 5 phr AAEM | 8.8 | 10 |
| Pilot 60LH242 | No primer | FL780-0.4 phr S45 | No AAEM | 92 | 118 |
| Coater 60LH242 | No primer | FL780-0.4 phr S45 | No AAEM | 83 | 112 |
| 60LH242 | Mica | FL780-0.4 phr S45 | 2 phr AAEM | 72 | 91 |
| 60LH242 | Mica | FL780-0.4 phr S45 | 5 phr AAEM | 96 | 116 |

Blocking tests were performed using the backsides of the 50LL539 (clear) and 60LH538 (white opaque) films as shown in Table 3. Tearability is the tendency of the sample used for the blocking test to tear when sheets are separated by hand at high speed (qualitative test): a value of 1 is the best, which equates to no tearing observed.

TABLE 3

| 1 | Printable side | Adhesive receptive side | Blocking | Values in gr/25 mm | Average | Tearability |
|---|---|---|---|---|---|---|
| 2 | Print 50LL539 (MICA primer) | Backside 50LL539 (Mica primer) | 7 | 8 | 8 | 1 |
| 3 | FL780 0.2 gr/m2/No PC | Adhesivable side 50LL539 | 9 | 9 | 9 | 1 |
| 4 | FL780 0.2 gr/m2/PEI | Adhesivable side 50LL539 | 10 | 11 | 11 | 1 |
| 5 | FL780 0.2 gr/m2/No PC-2 phr AAEM | Adhesivable side 50LL539 | 9 | 10 | 10 | 1 |
| 6 | FL780 0.2 gr/m2/PEI-2 phr AAEM | Adhesivable side 50LL539 | 11 | 10 | 11 | 1 |
| 7 | FL780 0.2 gr/m2/No PC-5 phr AAEM | Adhesivable side 50LL539 | 9 | 9 | 9 | 1 |
| 8 | FL780 0.2 gr/m2/No PC-5 phr AAEM | Adhesivable side 50LL539 | 9 | 11 | 10 | 1 |

All transparent versions showed very low blocking values. White opaque versions showed higher blocking values compared to transparent ones (higher compressibility), but it is worth mentioning that the addition of AAEM is never detrimental to the blocking values measured under accelerated conditions.

However, blocking tendency evaluation in reel is more reliable. The test consists in storing a slit roll (e.g., 320 mm wide, ˜500 m) in tropical conditions (i.e., 38° C. and 90% relative humidity) for one week and then, unwinding the slit roll at high speed (e.g., minimum 400 m/min) on a lab slitter. For both clear and white versions, insignificant blocking was exhibited even under these very critical test conditions.

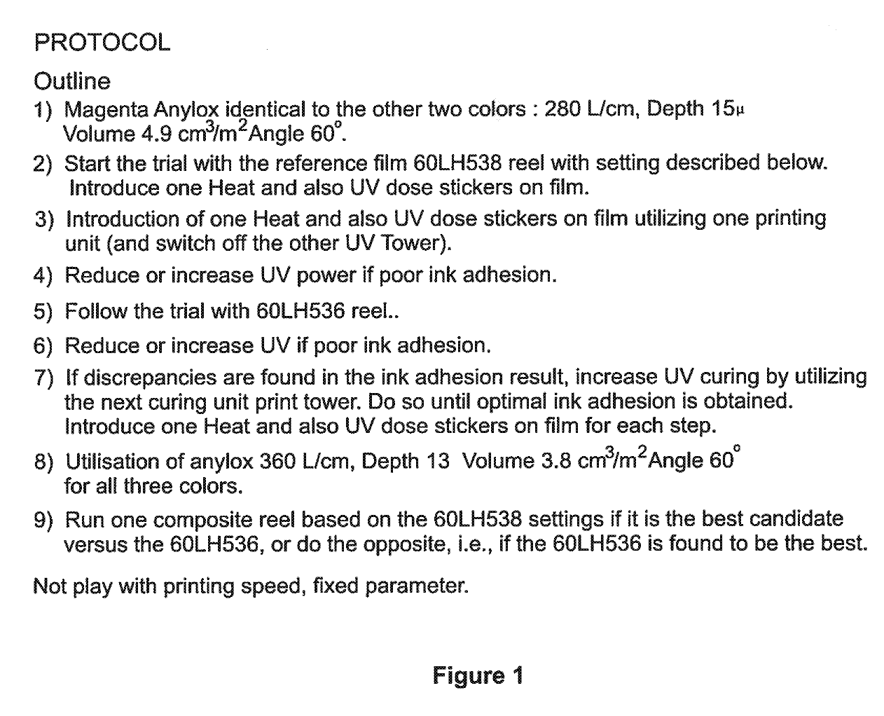

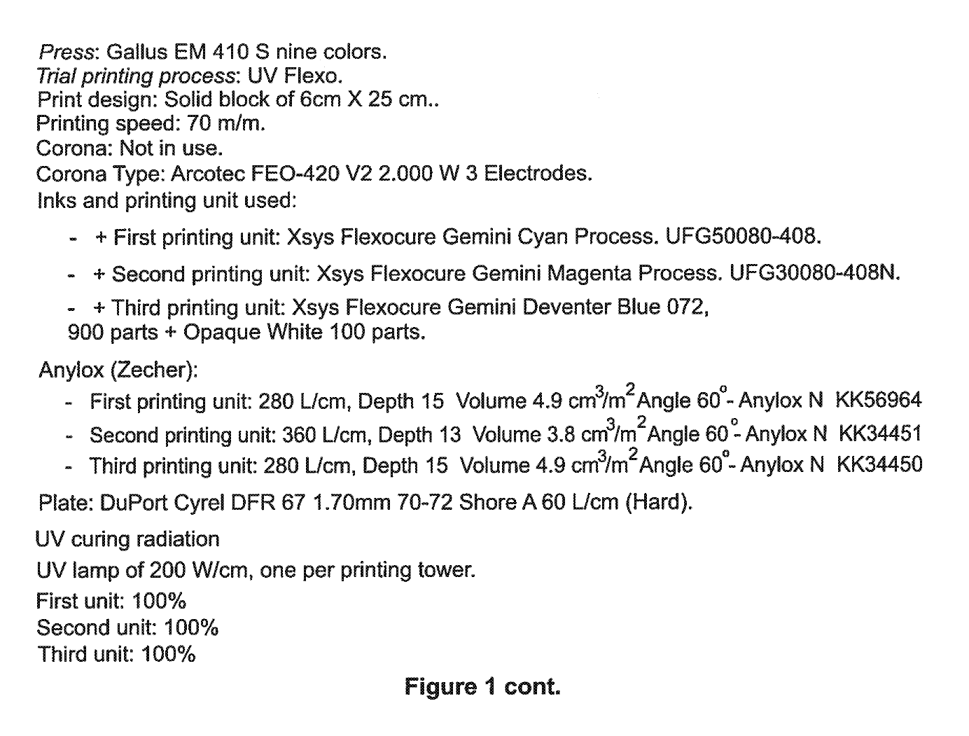

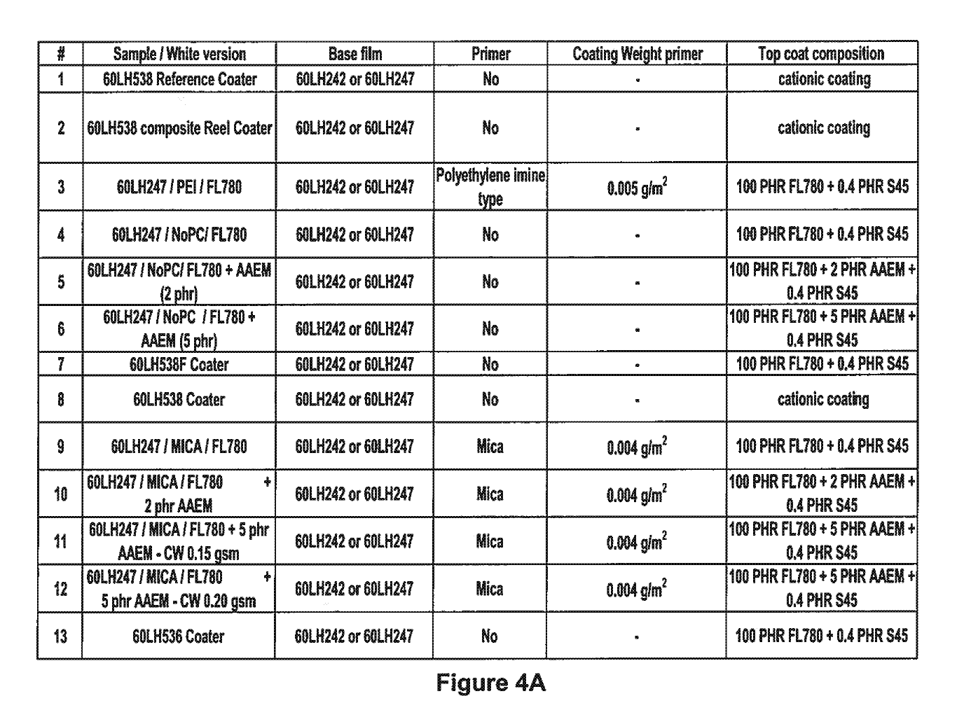

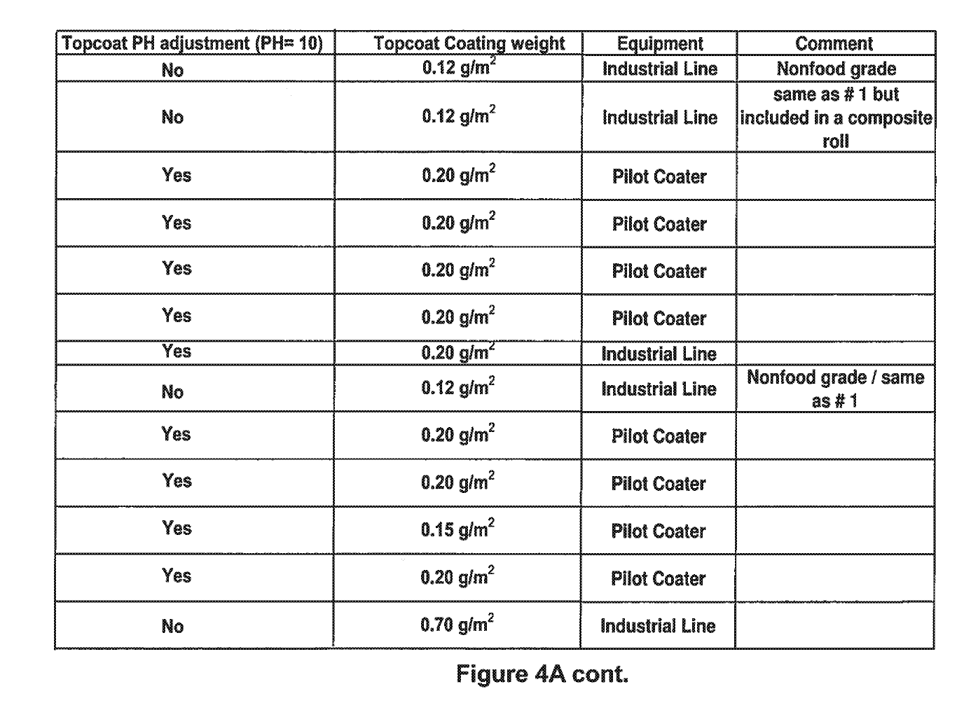

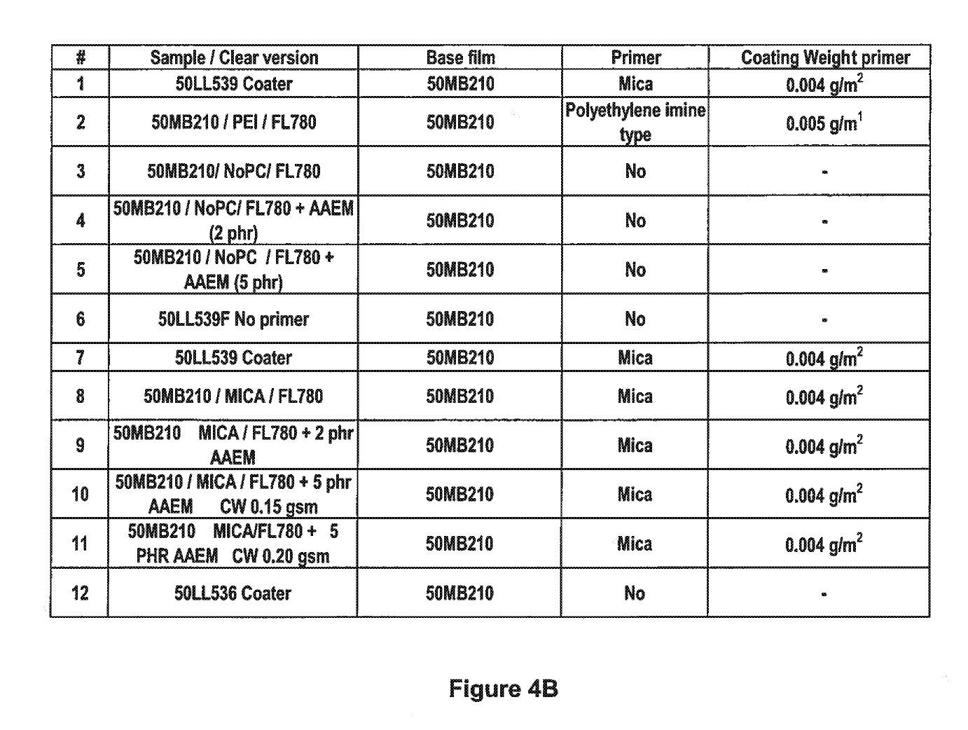

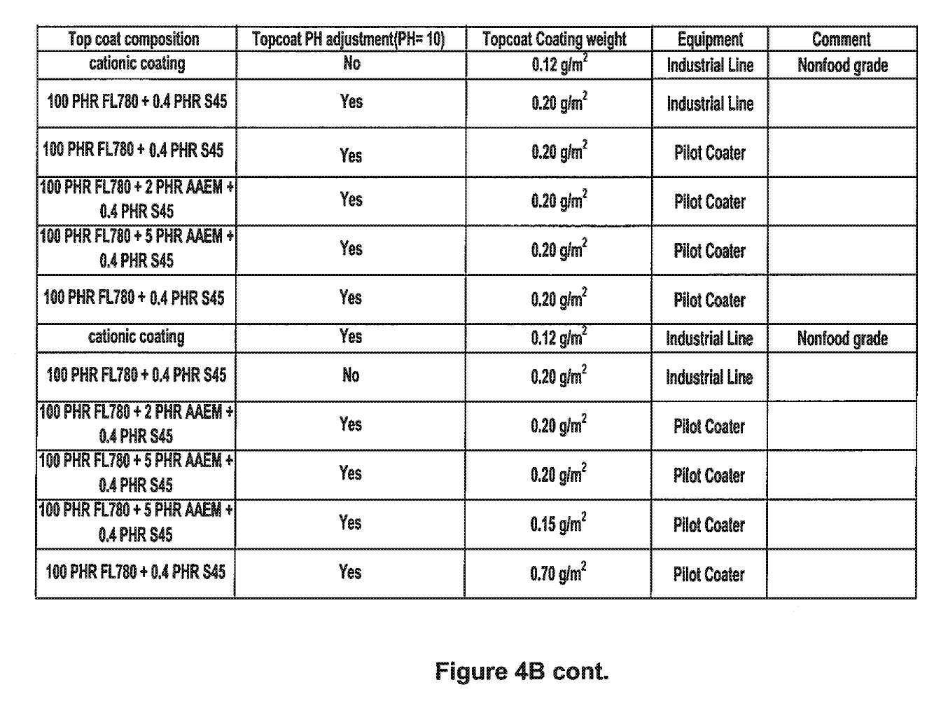

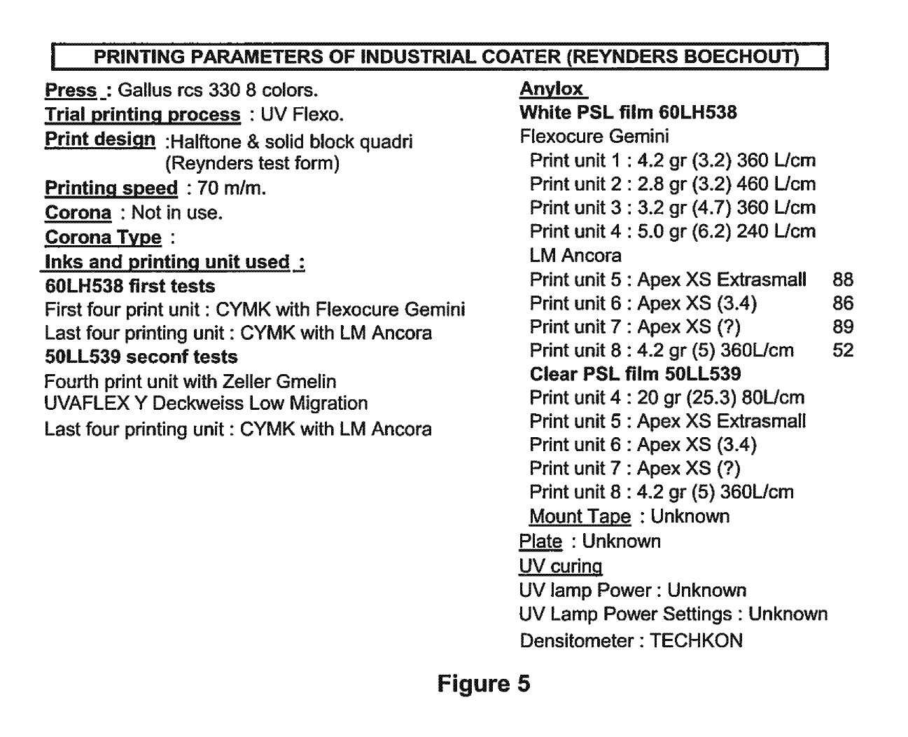

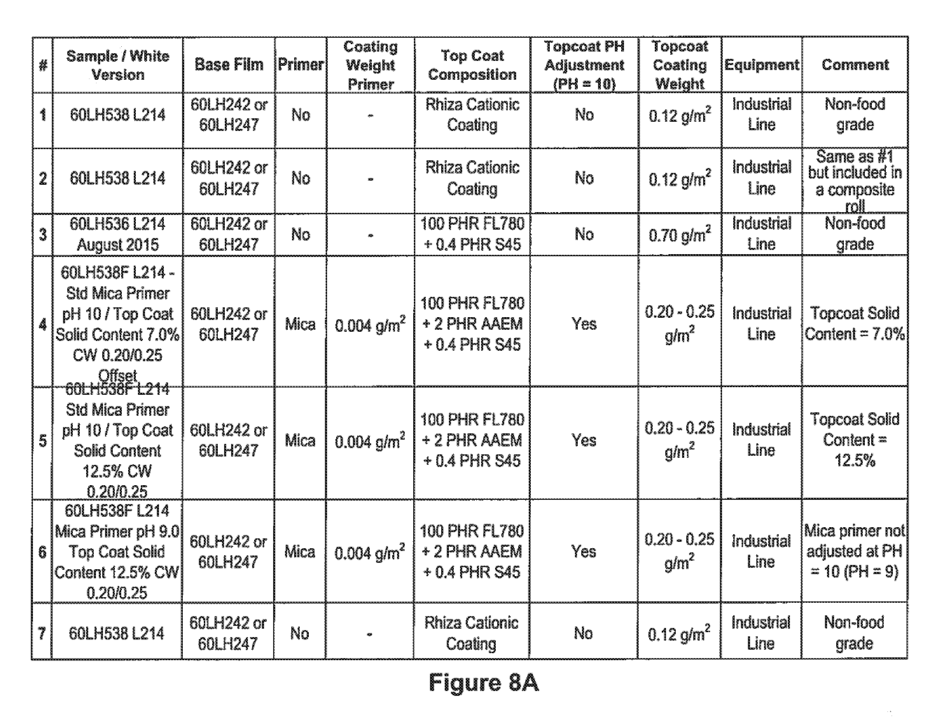

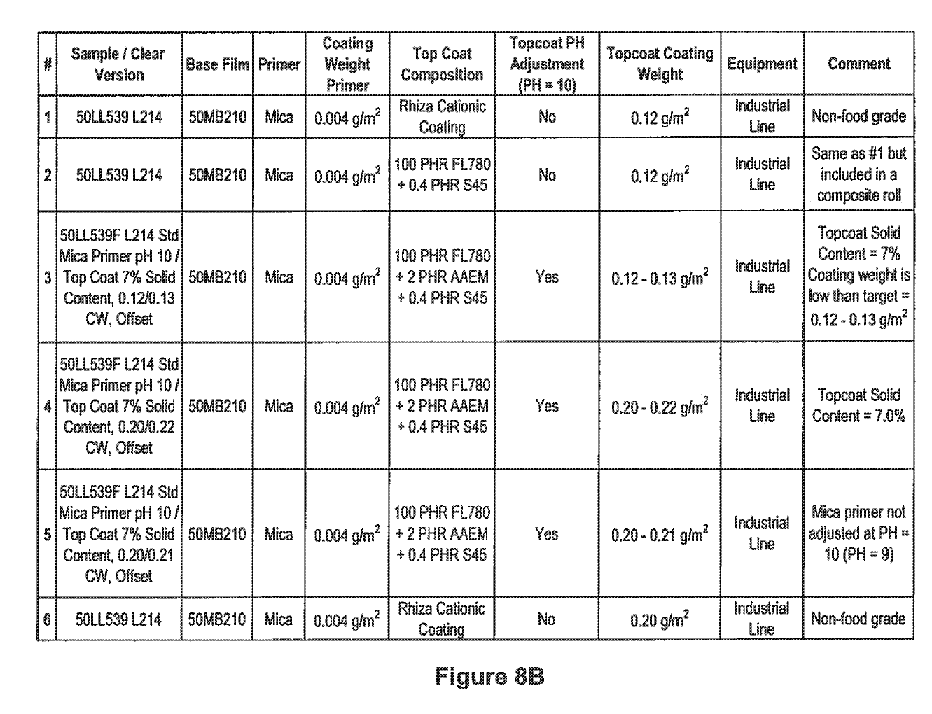

Turning now to print quality and ink adhesion, printing trials were performed with different variables and prepared both at the pilot coater, i.e., FIGS. 1-4B, and on an industrial coater, i.e., FIGS. 5-8B. Trials results on both clear and white opaque versions as well testing protocols are included in these figures. Low-migration, UV inks (which are more critical) were used for the clear version. The procedure relative to the evaluation of the ink or coating adhesion to flexible packaging materials is recorded as the percentage of ink remaining on the film after the tape test. Printing was performed at a printer (Reynders Boechout); 3M® Scotch 810 Magic™ tape was used for the adhesion test.

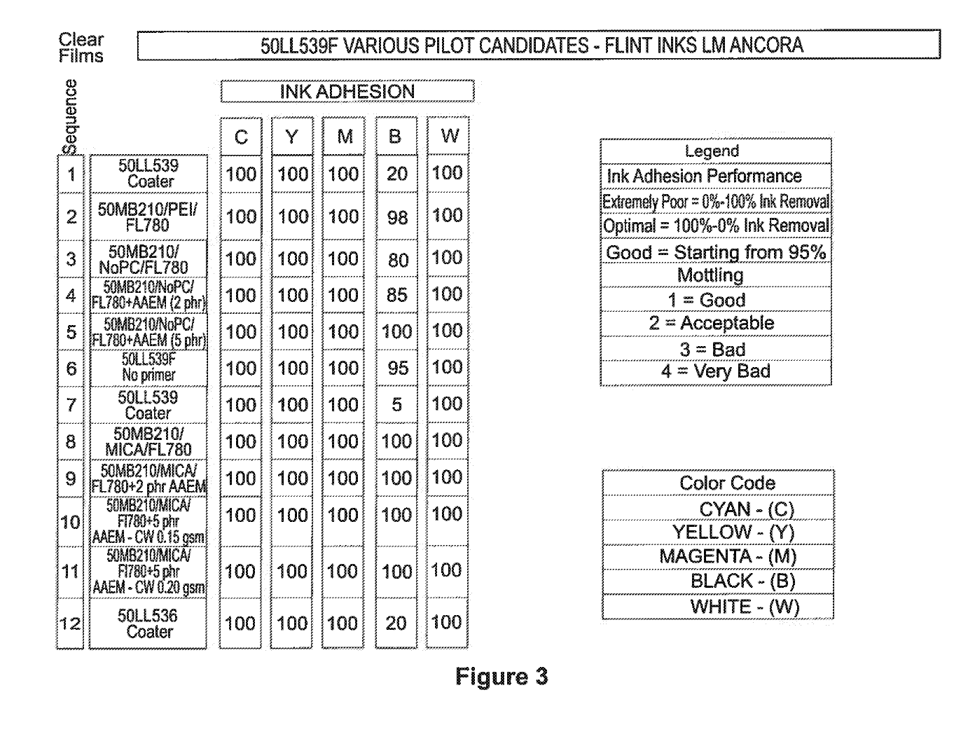

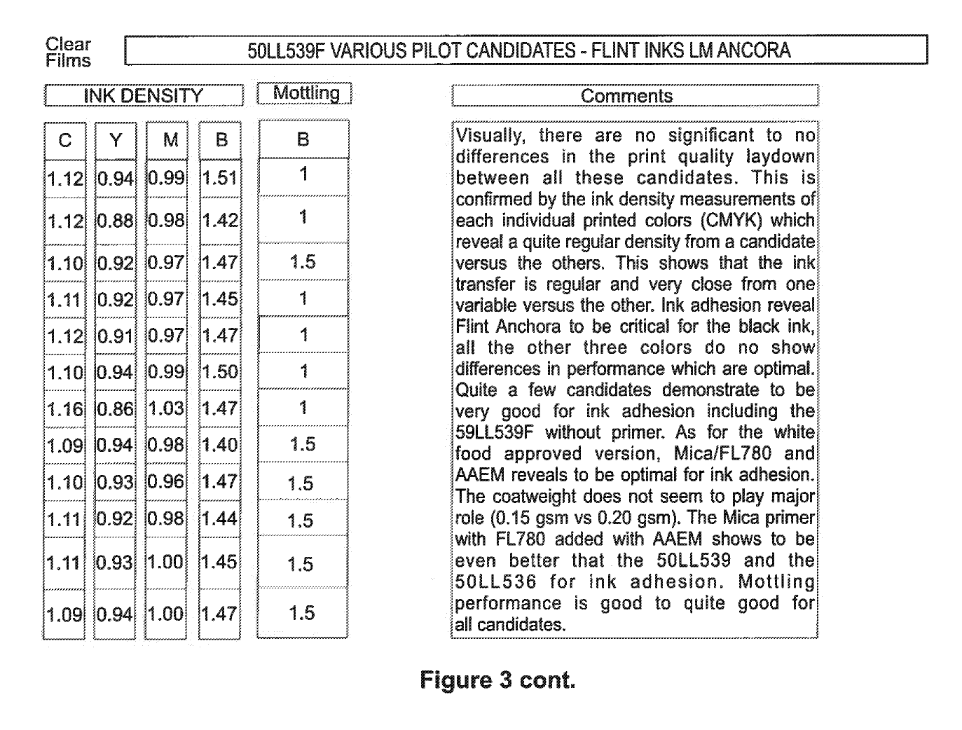

As far as the clear versions are concerned, i.e., FIG. 3, excellent results were observed with and without the adhesion promoter. However, the version with the adhesion promoter notably exceeds performances of a non-food-grade version.

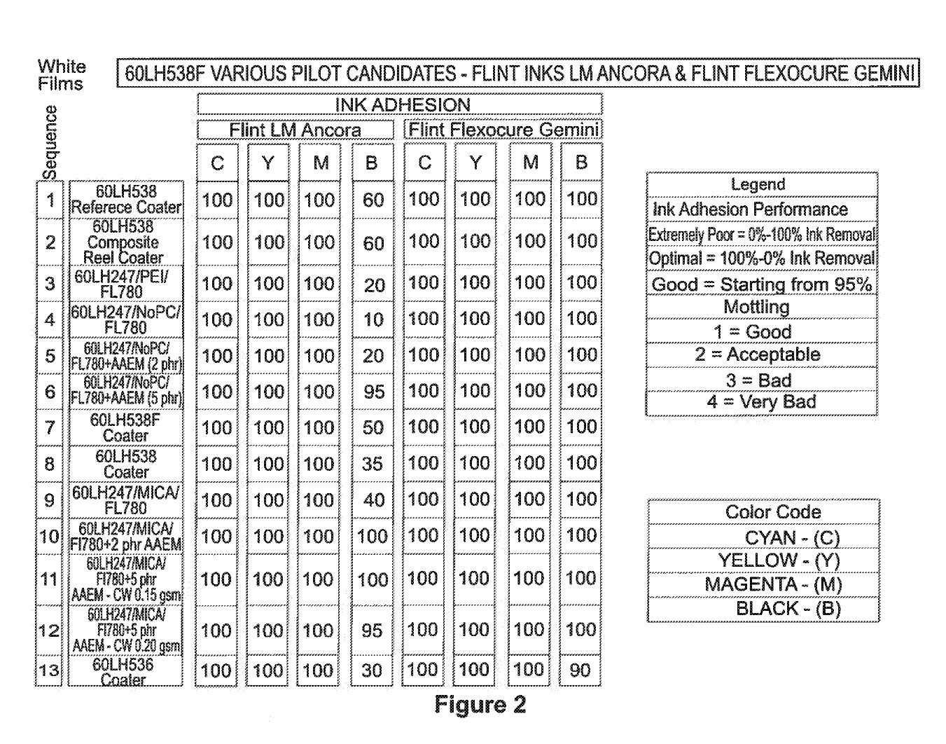

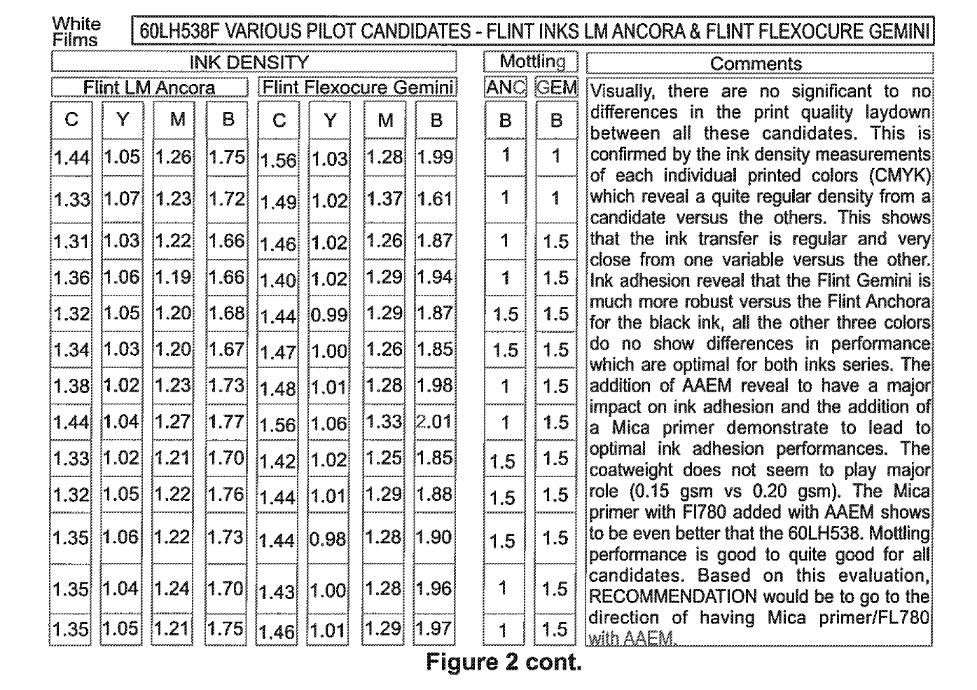

Regarding the white versions, i.e., FIG. 2, ink adhesion and density performances with low migration (LM Ancora) and standard UV inks are very similar to the non-food grade (reference) when adding 2 and 5 PHR AAEM.

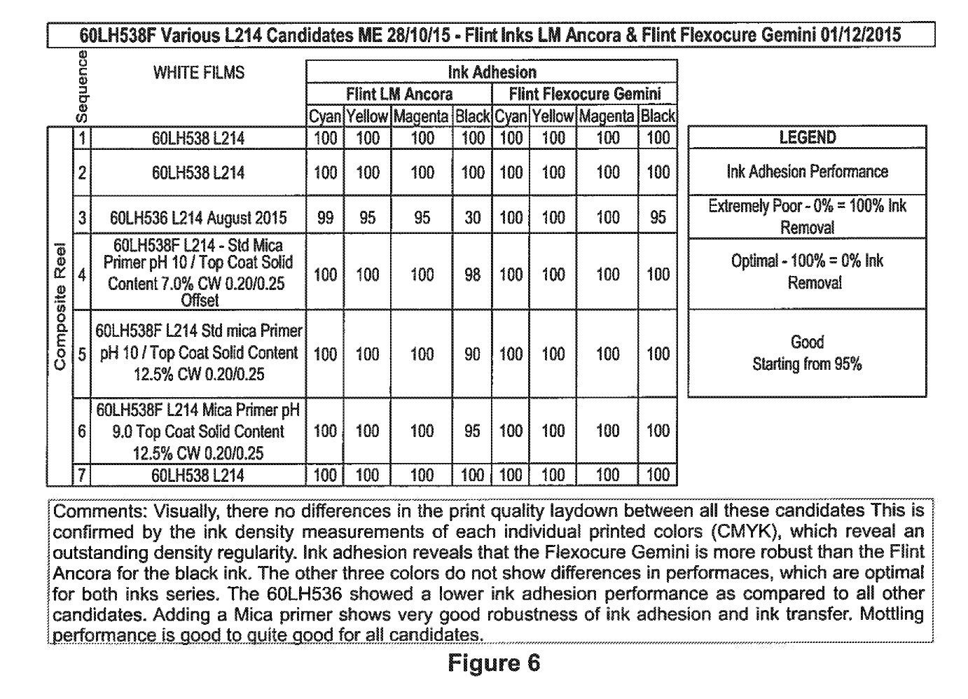

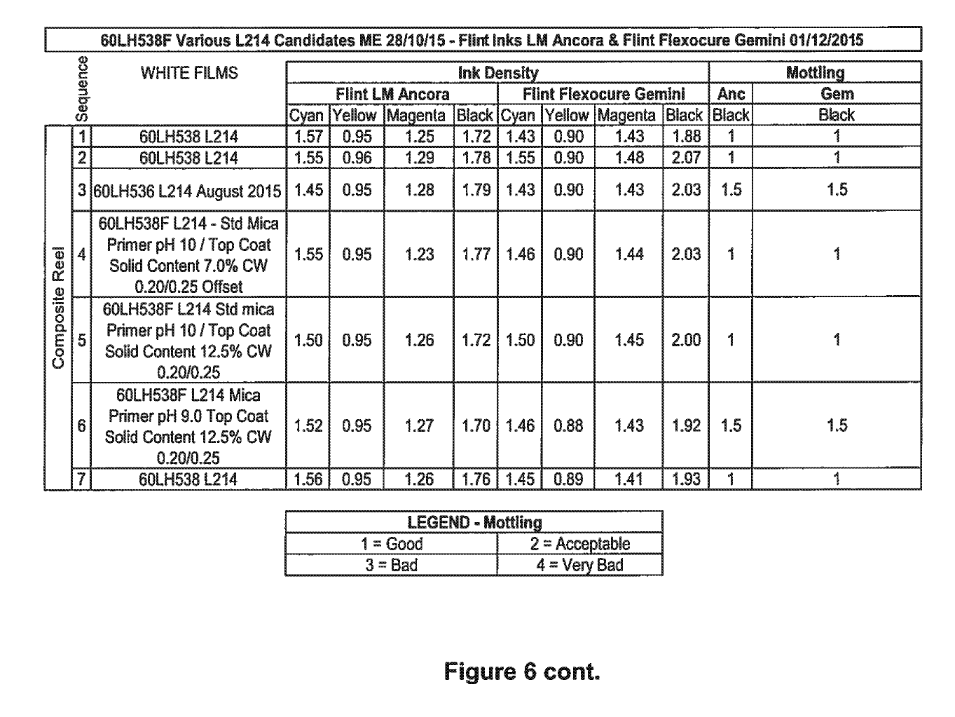

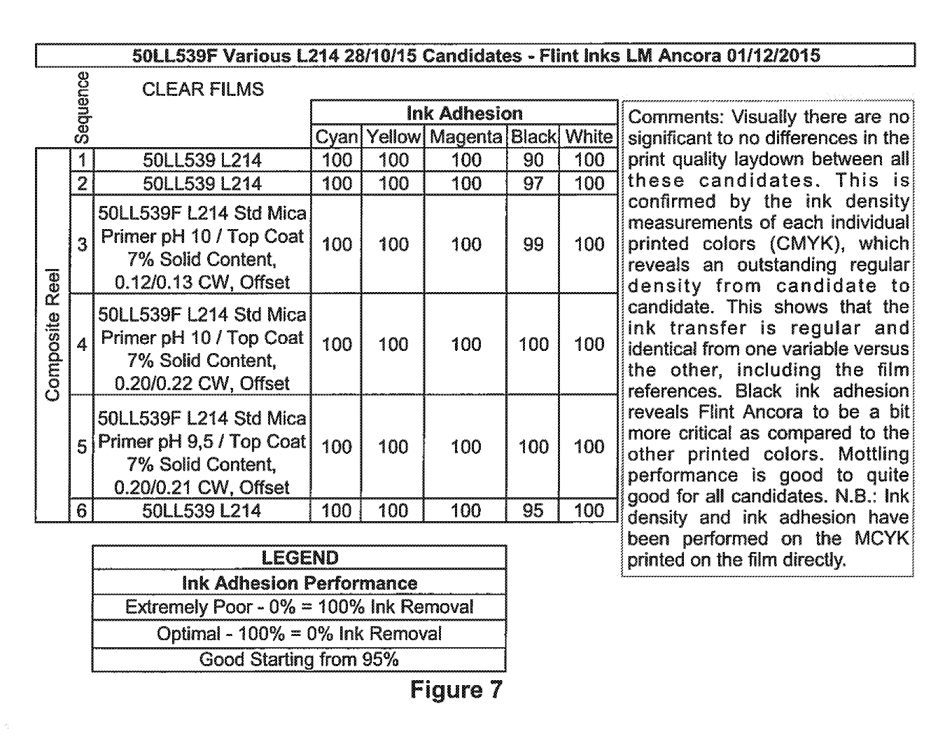

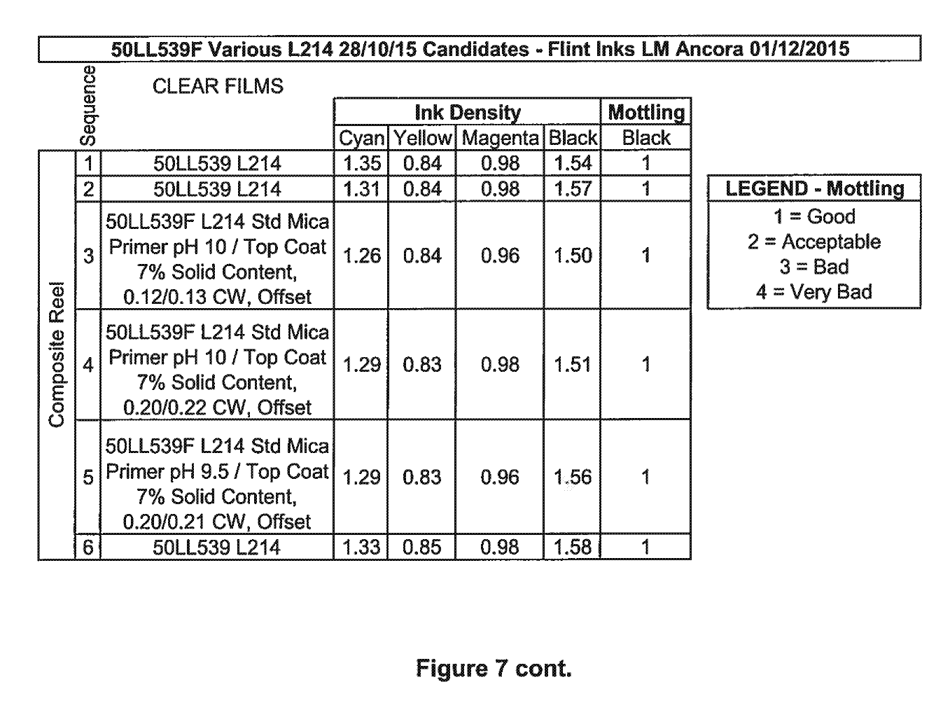

FIGS. 6 and 7 show the results of printing tests made on industrial coater samples. The results also clearly demonstrate that a lower coating weight (around 0.15-0.20 g/m²) and a pH adjustment (e.g., pH =9 or 10) are beneficial to the ink adhesion as shown by the poorer results of the 50LL536 and 60LH536 versions, which have higher coating weight (dry weight) and no pH adjustment.

Another parameter measure for the disclosed printable coatings on multilayered films is resistance to hot water. Haze values before and after 30 min in water at 80° C. (version without AAEM) were measured as shown in Table 4.

TABLE 4

Haze (%)

| | Before | After |
|---|---|---|
| 50LL539 standard version | 1.75-1.8 | 2.3-2.6 or 2.7 |
| 50LL539 food version (ME) | 1.95-2.00 | 2.3-2.4 |

Resistance to whitening after immersion in hot water was evaluated on both the current 50LL539 standard version (non-food) and the new NeoCryl® FL780-based version, which is an acrylic-based printable coating. Haze increase after 30 minutes in hot water is limited for both transparent versions, and, in fact, insignificant. Both versions were made on an industrial coater during a manufacturing experiment (“ME”). Final values remain at an acceptable level.

The NeoCryl® FL780-based printable coating's print quality and ink adhesion may be improved by using acetoacetoxyethyl methacrylate (AEEM) adhesion promoter, both on transparent and white films, whether cavitated or not. Low coating weights, i.e., around 0.1-0.2 g/m² dry and the addition of ammonia to further increase the pH (e.g., at least 9 to 10 is preferred) are additional factors of improvement. This kind of coating formulation was also found to keep the level of blocking/sticking tendency in reel at a very low level. Various films structures with different adhesive receptive layers (backside) were successfully tested. As a consequence, NeoCryl® FL780 XP-based coating with some AAEM shows equivalent printability properties (and even better in some cases) to other more sophisticated (e.g., cationic) coatings. Further, such printable coatings comply with the new European regulations for food contact.

The printable coatings herein described are also a potential building block to further enhancing the performances of films and PSL applications, both in terms of printability and other properties like blocking in reel, haze, coefficient of friction, and so forth.

Returning to the description of the multilayered films capable of use with the disclosed printable coatings, the multilayered films may or may not be uniaxially or biaxially oriented. Orientation in the direction of extrusion is known as machine direction (“MD”) orientation. Orientation perpendicular to the direction of extrusion is known as transverse direction (“TD”) orientation. Orientation may be accomplished by stretching or pulling a film first in the MD followed by the TD. Orientation may be sequential or simultaneous, depending upon the desired film features. Orientation ratios are commonly from between about three to about six times the extruded width in the MD and between about four to about ten times the extruded width in the TD.

Blown films may be oriented by controlling parameters such as take up and blow up ratio. Cast films may be oriented in the MD direction by take up speed, and in the TD through use of tenter equipment. Blown films or cast films may also be oriented by tenter-frame orientation subsequent to the film extrusion process, in one or both directions. Typical commercial orientation processes are BOPP tenter process and Linear Motor Simultaneous Stretching (“LISIM”) technology.

One or both of the outer exposed surfaces of the multilayered films may be surface-treated to increase the surface energy of the film to render the film receptive to metallization, coatings, printing inks, and/or lamination. The surface treatment may be carried out according to one of the methods known in the art. Exemplary treatments include, but are not limited to, corona-discharge, flame, plasma, chemical, by means of a polarized flame, or otherwise.

In some embodiments, the film may first be surface treated, for example, by corona treatment, and then be treated again in the coating line, for example, by flame treatment, immediately prior to being coated. In additional or alternative embodiments, the film may first be surface treated, for example, by flame treatment, and then be treated again in the metallization chamber, for example, by plasma treatment, immediately prior to being metallized.

As discussed above, return to a further description of the multilayered film, including orientation, optional layers, treatments, and now ensures. In addition, a discussion of

### Core Layer

The core layer of a multilayered film is most commonly the thickest layer and provides the foundation of the multilayered structure. In some embodiments and in addition to the foregoing discussion of the core, the core layer consists essentially of non-oriented, monoaxially oriented, or biaxially polymers, such as biaxially oriented polypropylene (“BOPP”), biaxially oriented polyester (“BOPET”), biaxially oriented polylactic acid (“BOPLA”), and combinations thereof, and may be substantially free from other components. In alternate embodiments, the core may also contain lesser amounts of additional polymer(s) selected from the group consisting of ethylene polymer, ethylene-propylene copolymers, ethylene-propylene-butene terpolymers, elastomers, plastomers, different types of metallocene-LLDPEs (m-LLDPEs), and combinations thereof.

The core layer may further include a hydrocarbon resin. Hydrocarbon resins may serve to enhance or modify the flexural modulus, improve processability, or improve the barrier properties of the film. The resin may be a low molecular weight hydrocarbon that is compatible with the core polymer. Optionally, the resin may be hydrogenated. The resin may have a number average molecular weight less than 5000, preferably less than 2000, most preferably in the range of from 500 to 1000. The resin can be natural or synthetic and may have a softening point in the range of from 60° C. to 180° C.

Suitable hydrocarbon resins include, but are not limited to petroleum resins, terpene resins, styrene resins, and cyclopentadiene resins. In some embodiments, the hydrocarbon resin is selected from the group consisting of aliphatic hydrocarbon resins, hydrogenated aliphatic hydrocarbon resins, aliphatic/aromatic hydrocarbon resins, hydrogenated aliphatic aromatic hydrocarbon resins, cycloaliphatic hydrocarbon resins, hydrogenated cycloaliphatic resins, cycloaliphatic/aromatic hydrocarbon resins, hydrogenated cycloaliphatic/aromatic hydrocarbon resins, hydrogenated aromatic hydrocarbon resins, polyterpene resins, terpene-phenol resins, rosins and rosin esters, hydrogenated rosins and rosin esters, and combinations thereof.

The amount of such hydrocarbon resins, either alone or in combination, in the core layer is preferably less than 20 wt %, more preferably in the range of from 1 wt % to 5 wt %, based on the total weight of the core layer.

The core layer may further comprise one or more additives such as opacifying agents, pigments, colorants, cavitating agents, slip agents, antioxidants, anti-fog agents, anti-static agents, fillers, moisture barrier additives, gas barrier additives, and combinations thereof, as discussed in further detail below. A suitable anti-static agent is ARMOSTAT™ 475 (commercially available from Akzo Nobel of Chicago, Ill.).

Cavitating agents may be present in the core layer in an amount less than 30 wt %, preferably less than 20 wt %, most preferably in the range of from 2 wt % to 10 wt %, based on the total weight of the core layer.

Preferably, the total amount of additives in the core layer comprises up to about 20 wt % of the core layer, but some embodiments may comprise additives in the core layer in an amount up to about 30 wt % of the core layer.

The core layer preferably has a thickness in the range of from about 5 μm to 100 μm, more preferably from about 5 μm to 50 μm, most preferably from 5μm to 25 μm.

### Tie Layer(s)

Tie layer(s) of a multilayered film is typically used to connect two other layers of the multilayered film structure, e.g., a core layer and a sealant layer, and is positioned intermediate these other layers. The tie layer(s) may have the same or a different composition as compared to the core layer.

In some embodiments, the tie layer is in direct contact with the surface of the core layer. In other embodiments, another layer or layers may be intermediate the core layer and the tie layer. The tie layer may comprise one or more polymers. In addition, the polymers may include C₂ polymers, maleic-anhydride-modified polyethylene polymers, C₃ polymers, C₂C₃ random copolymers, C₂C₃C₄ random terpolymers, heterophasic random copolymers, C₄ homopolymers, C₄ copolymers, metallocene polymers, propylene-based or ethylene-based elastomers and/or plastomers, ethyl-methyl acrylate (EMA) polymers, ethylene-vinyl acetate (EVA) polymers, polar copolymers, and combinations thereof. For example, one polymer may be a grade of VISTAMAXX™ polymer (commercially available from ExxonMobil Chemical Company of Baytown, Tex.), such as VM6100 and VM3000 grades. Alternatively, suitable polymers may include VERSIFY™ polymer (commercially available from The Dow Chemical Company of Midland, Mich.), Basell CATALLOY™ resins such as ADFLEX™ T100F, SOFTELL™ Q020F, CLYRELL™ SM1340 (commercially available from Basell Polyolefins of The Netherlands), PB (propylene-butene-1) random copolymers, such as Basell PB 8340 (commercially available from Basell Polyolefins of The Netherlands), Borealis BORSOFT™ SD233CF, (commercially available from Borealis of Denmark), EXCEED™ 1012CA and 1018CA metallocene polyethylenes, EXACT™ 5361, 4049, 5371, 8201, 4150, 3132 polyethylene plastomers, EMCC 3022.32 low density polyethylene (LDPE) (commercially available from ExxonMobil Chemical Company of Baytown, Tex.).

In some embodiments, the tie layer may further comprise one or more additives such as opacifying agents, pigments, colorants, cavitating agents, slip agents, antioxidants, anti-fog agents, anti-static agents, anti-block agents, fillers, moisture barrier additives, gas barrier additives, and combinations thereof, as discussed in further detail below.

The thickness of the tie layer is typically in the range of from about 0.50 to 25 μm, preferably from about 0.50 μm to 12 μm, more preferably from about 0.50 μm to 6μm, and most preferably from about 2.5 μm to 5 μm. However, in some thinner films, the tie layer thickness may be from about 0.5 μm to 4μm, or from about 0.5 μm to 2μm, or from about 0.5 μm to 1.5 μm.

### Sealant Layer

In some embodiments, there may be an optional sealant layers. Furthermore, the sealant layer may be on one or both sides of the core layer, and each sealant layer may have the same or a different composition. In addition, each sealant layer may have the same or different composition as compared to the core. In still other embodiments, one or more other layers may be intermediate the core layer and the sealant layer. The sealant layer includes a polymer that is suitable for heat-sealing or bonding to itself when crimped between heated crimp-sealer jaws. Suitable sealant layers include one or more polymers, including homopolymers, copolymers of ethylene, propylene, butene, hexene, heptene, octene, and combinations thereof. Additionally and alternatively, the suitable sealant layer composition has a melting peak equal to or less than the melting peak of the core layer. More particularly, the sealant layer may comprise at least one polymer selected from the group consisting of ethylene-propylene-butylene (EPB) terpolymer, ethylene vinyl acetate (EVA), metallocene-catalyzed ethylene, LLDPE, ionomer, polyethylene elastomer, plastomer, and combinations thereof.

The sealant layer may also comprise processing aid additives, such as anti-block agents, anti-static agents, slip agents and combinations thereof, as discussed in further detail below.

The thickness of the sealant layer is typically in the range of from about 0.10 μm to 7.0 μm, preferably about 0.10 μm to 4 μm, and most preferably about 1 μm to 3 μm. In some film embodiments, the sealant layer thickness may be from about 0.10 μm to 2 μm, 0.10 μm to 1 μm, or 0.10 μm to 0.50 μm. In some commonly preferred film embodiments, the sealant layer has a thickness in the range of from about 0.5 μm to 2 μm, 0.5 μm to 3 μm, or 1μm to 3.5 um.

In some embodiments, the skin layer comprises at least one polymer selected from the group consisting of a polyethylene polymer or copolymer, a polypropylene polymer or copolymer, an ethylene-propylene copolymer, an ethylene-propylene-butene terpolymer, a propylene-butene copolymer, an ethylene-vinyl alcohol polymer, polyamide polymer or copolymer, and combinations thereof. Preferably, the polyethylene polymer is high-density polyethylene (HDPE), such as HD-6704.67 (commercially available from ExxonMobil Chemical Company of Baytown, Tex.), M-6211 and HDPE M-6030 (commercially available from Equistar Chemical Company of Houston, Tex.). A suitable ethylene-propylene copolymer is Fina 8573 (commercially available from Fina Oil Company of Dallas, Tex.). Preferred EPB terpolymers include Chisso 7510 and 7794 (commercially available from Chisso Corporation of Japan). For coating and printing functions, the skin layer may preferably comprise a copolymer that has been surface treated. For metallizing or barrier properties, an HDPE or EVOH polymer may be preferred, such as one that has a melting peak of less than 160° C.

The skin layer may also comprise processing aid additives, such as anti-block agents, anti-static agents, slip agents and combinations thereof, as discussed in further detail below.

The thickness of the skin layer depends upon the intended function of the skin layer, but is typically in the range of from about 0.50 μm to 3.5 μm, preferably from about 0.50 μm to 2μm, and in many embodiments most preferably from about 0.50 μm to 1.5 μm. Also, in thinner film embodiments, the skin layer thickness may range from about 0.50 μm to 1.0 μm, or 0.50 μm to 0.75 μm.

### Additives

Additives that may be present in one or more layers of the multilayered films, include, but are not limited to opacifying agents, pigments, colorants, cavitating agents, slip agents, antioxidants, anti-fog agents, anti-static agents, anti-block agents, fillers, moisture barrier additives, gas barrier additives, gas scavengers, and combinations thereof. Such additives may be used in effective amounts, which vary depending upon the property required.

Examples of suitable opacifying agents, pigments or colorants are iron oxide, carbon black, aluminum, titanium dioxide (TiO₂), calcium carbonate (CaCO₃), and combinations thereof.

Cavitating or void-initiating additives may include any suitable organic or inorganic material that is incompatible with the polymer material(s) of the layer(s) to which it is added, at the temperature of biaxial orientation, in order to create an opaque film. Examples of suitable void-initiating particles are PBT, nylon, solid or hollow pre-formed glass spheres, metal beads or spheres, ceramic spheres, calcium carbonate, talc, chalk, or combinations thereof. The average diameter of the void-initiating particles typically may be from about 0.1 to 10 μm.

Slip agents may include higher aliphatic acid amides, higher aliphatic acid esters, waxes, silicone oils, and metal soaps. Such slip agents may be used in amounts ranging from 0.1 wt % to 2 wt % based on the total weight of the layer to which it is added. An example of a slip additive that may be useful is erucamide.

Non-migratory slip agents, used in one or more skin layers of the multilayered films, may include polymethyl methacrylate (PMMA). The non-migratory slip agent may have a mean particle size in the range of from about 0.5 μm to 8 μm, or 1 μm to 5 μm, or 2 μm to 4 μm, depending upon layer thickness and desired slip properties. Alternatively, the size of the particles in the non-migratory slip agent, such as PMMA, may be greater than 20% of the thickness of the skin layer containing the slip agent, or greater than 40% of the thickness of the skin layer, or greater than 50% of the thickness of the skin layer. The size of the particles of such non-migratory slip agent may also be at least 10% greater than the thickness of the skin layer, or at least 20% greater than the thickness of the skin layer, or at least 40% greater than the thickness of the skin layer. Generally spherical, particulate non-migratory slip agents are contemplated, including PMMA resins, such as EPOSTAR™ (commercially available from Nippon Shokubai Co., Ltd. of Japan). Other commercial sources of suitable materials are also known to exist. Non-migratory means that these particulates do not generally change location throughout the layers of the film in the manner of the migratory slip agents. A conventional polydialkyl siloxane, such as silicone oil or gum additive having a viscosity of 10,000 to 2,000,000 centistokes is also contemplated.

Suitable anti-oxidants may include phenolic anti-oxidants, such as IRGANOX® 1010 (commercially available from Ciba-Geigy Company of Switzerland). Such an anti-oxidant is generally used in amounts ranging from 0.1 wt % to 2 wt %, based on the total weight of the layer(s) to which it is added.

Anti-static agents may include alkali metal sulfonates, polyether-modified polydiorganosiloxanes, polyalkylphenylsiloxanes, and tertiary amines Such anti-static agents may be used in amounts ranging from about 0.05 wt % to 3 wt %, based upon the total weight of the layer(s).

Examples of suitable anti-blocking agents may include silica-based products such as SYLOBLOC® 44 (commercially available from Grace Davison Products of Colombia, Md.), PMMA particles such as EPOSTAR™ (commercially available from Nippon Shokubai Co., Ltd. of Japan), or polysiloxanes such as TOSPEARL™ (commercially available from GE Bayer Silicones of Wilton, Conn.). Such an anti-blocking agent comprises an effective amount up to about 3000 ppm of the weight of the layer(s) to which it is added.

Useful fillers may include finely divided inorganic solid materials such as silica, fumed silica, diatomaceous earth, calcium carbonate, calcium silicate, aluminum silicate, kaolin, talc, bentonite, clay and pulp.

Suitable moisture and gas barrier additives may include effective amounts of low-molecular weight resins, hydrocarbon resins, particularly petroleum resins, styrene resins, cyclopentadiene resins, and terpene resins.

Optionally, one or more skin layers may be compounded with a wax or coated with a wax-containing coating, for lubricity, in amounts ranging from 2 wt % to 15 wt % based on the total weight of the skin layer. Any conventional wax, such as, but not limited to Carnauba™ wax (commercially available from Michelman Corporation of Cincinnati, Ohio) that is useful in thermoplastic films is contemplated.

### Orientation

The embodiments include possible uniaxial or biaxial orientation of the multilayered films. Orientation in the direction of extrusion is known as machine direction (MD) orientation. Orientation perpendicular to the direction of extrusion is known as transverse direction (TD) orientation. Orientation may be accomplished by stretching or pulling a film first in the MD followed by TD orientation. Blown films or cast films may also be oriented by a tenter-frame orientation subsequent to the film extrusion process, again in one or both directions. Orientation may be sequential or simultaneous, depending upon the desired film features. Preferred orientation ratios are commonly from between about three to about six times the extruded width in the machine direction and between about four to about ten times the extruded width in the transverse direction. Typical commercial orientation processes are tenter process, blown film, and LISIM technology.

### Surface Treatment

One or both of the outer surfaces of the multilayered films, and, in particular, the sealant layers, may be surface-treated to increase the surface energy to render the film receptive to metallization, coatings, printing inks, adhesives, and/or lamination. The surface treatment can be carried out according to one of the methods known in the art including corona discharge, flame, plasma, chemical treatment, or treatment by means of a polarized flame.

### Metallization

The multilayered films may be primed, coated and then metallized. For example, the outer surface (i.e., side facing away from the core) of the skin layer, which is on the opposite side of the core as compared to the sealant layer, may undergo metallization after optionally being treated. Metallization may be carried out through conventional methods, such as vacuum metallization by deposition of a metal layer such as aluminum, copper, silver, chromium, or mixtures thereof.

### Primers

Primer materials are well known in the art and include, for example, epoxy, poly(ethylene imine) (PEI), and polyurethane materials. U.S. Pat. No. 3,753,769, U.S. Pat. No. 4,058,645 and U.S. Pat. No. 4,439,493, each incorporated herein by reference, discloses the use and application of such primers. The primer provides an overall adhesively active surface for thorough and secure bonding with the subsequently applied coating composition and can be applied to the film by conventional solution coating means, for example, by roller application.

The coating composition may be water-based emulsions that may use one or more surfactants to disperse and stabilize the polymer(s) and additives comprising the coating composition. The coating composition may be applied to the film as a solution, one prepared with an organic solvent such as an alcohol, ketone, ester, and the like. It is preferable that the coating composition be applied to the treated surface in any convenient manner, such as by gravure coating, roll coating, dipping, spraying, and the like. The excess aqueous solution can be removed by squeeze rolls, doctor knives, and the like.

### Orienting

The films herein are also characterized in certain embodiments as being biaxially oriented. The films can be made by any suitable technique known in the art, such as a tentered or blown process, LISIMTM, and others. Further, the working conditions, temperature settings, lines speeds, etc. will vary depending on the type and the size of the equipment used. Nonetheless, described generally here is one method of making the films described throughout this specification. In a particular embodiment, the films are formed and biaxially oriented using the tentered method. In the tentered process, line speeds of greater than 100 m/min to 400 m/min or more, and outputs of greater than 2000 kg/hr to 4000 kg/hr or more are achievable. In the tenter process, sheets/films of the various materials are melt blended and coextruded, such as through a 3, 4, 5, 7-layer die head, into the desired film structure. Extruders ranging in diameters from 100 mm to 300 or 400 mm, and length to diameter ratios ranging from 10/1 to 50/1 can be used to melt blend the molten layer materials, the melt streams then metered to the die having a die gap(s) within the range of from 0.5 or 1 to an upper limit of 3 or 4 or 5 or 6 mm The extruded film is then cooled using air, water, or both. Typically, a single, large diameter roll partially submerged in a water bath, or two large chill rolls set at 20 or 30 to 40 or 50 or 60 or 70° C. are suitable cooling means. As the film is extruded, an air knife and edge pinning are used to provide intimate contact between the melt and chill roll.

Downstream of the first cooling step in this embodiment of the tentered process, the unoriented film is reheated to a temperature of from 80 to 100 or 120 or 150° C., in one embodiment by any suitable means such as heated S-wrap rolls, and then passed between closely spaced differential speed rolls to achieve machine direction orientation. It is understood by those skilled in the art that this temperature range can vary depending upon the equipment, and in particular, upon the identity and composition of the components making up the film. Ideally, the temperature will be below that which will melt the film, but high enough to facilitate the machine direction orientation process. Such temperatures referred to herein refer to the film temperature itself. The film temperature can be measured by using, for example, infrared spectroscopy, the source aimed at the film as it is being processed; those skilled in the art will understand that for transparent films, measuring the actual film temperature will not be as precise. The heating means for the film line may be set at any appropriate level of heating, depending upon the instrument, to achieve the stated film temperatures.

The lengthened and thinned film is passed to the tenter section of the line for TD orientation. At this point, the edges of the sheet are grasped by mechanical clips on continuous chains and pulled into a long, precisely controlled hot air oven for a pre-heating step. The film temperatures range from 100 or 110 to 150 or 170 or 180° C. in the pre-heating step. Again, the temperature will be below that which will melt the film, but high enough to facilitate the step of transverse direction orientation. Next, the edges of the sheet are grasped by mechanical clips on continuous chains and pulled into a long, precisely controlled hot air oven for transverse stretching. As the tenter chains diverge a desired amount to stretch the film in the transverse direction, the process temperature is lowered by at least 2° C. but typically no more than 20° C. relative to the pre-heat temperature to maintain the film temperature so that it will not melt the film. After stretching to achieve transverse orientation in the film, the film is annealed at a temperature below the melting point, and the film is then cooled from 5 to 10 or 15 or 20 or 30 or 40° C. below the stretching temperature, and the clips are released prior to edge trim, optional coronal, printing and/or other treatment can then take place, followed by winding.

Thus, TD orientation is achieved by the steps of pre-heating the film having been machine oriented, followed by stretching and annealing it at a temperature below the melt point of the film, and then followed by a cooling step at yet a lower temperature. In one embodiment, the films described herein are formed by imparting a transverse orientation by a process of first pre-heating the film, followed by a decrease in the temperature of the process within the range of from 2 or 3 to 5 to 10 or 15 or 20° C. relative to the pre-heating temperature while performing transverse orientation of the film, followed by a lowering of the temperature within the range of from 5° C. to 10 or 15 or 20 or 30 or 40° C. relative to the melt point temperature, holding or slightly decreasing (more than 5%) the amount of stretch, to allow the film to anneal. The latter step imparts the low TD shrink characteristics of the films described herein. Thus, for example, where the pre-heat temperature is 120° C., the stretch temperature may be 114° C., and the cooling step may be 98° C., or any temperature within the ranges disclosed. The steps are carried out for a sufficient time to affect the desired film properties as those skilled in the art will understand.

Thus, in certain embodiments the film(s) described herein are biaxially oriented with at least a 5 or 6 or 7 or 8-fold TD orientation and at least a 2 or 3 or 4-fold MD orientation. Being so formed, the at least three-layer (one core, two skin layers, 18-21 μm thickness) possess an ultimate tensile strength within the range of from 100 or 110 to 80 or 90 or 200 MPa in the TD in certain embodiments; and possess an ultimate tensile strength within the range of from 30 or 40 to 150 or 130 MPa in the MD in other embodiments. Further, the SCS films described herein possess an MD Elmendorf tear is greater than 10 or 15 g in certain embodiments, and the TD Elmendorf tear is greater than 15 or 20 g in other embodiments.

While the foregoing is directed to example embodiments of the disclosed invention, other and further embodiments may be devised without departing from the basic scope thereof, wherein the scope of the disclosed applications, compositions, structures, labels, and so forth are determined by one or more claims of at least one subsequently filed, non-provisional patent application.

What is claimed is:

1. A film comprising:
a multilayered film comprising a core and at least one printable coating applied to at least one outer surface of the multi-layered film; and
the at least one printable coating comprises an acrylic-based polymer,
wherein the at least one printable coating has a dry coating weight is within a range from 0.1 g/m² to less than 0.5 g/m² and has a pH of at least 9,
wherein the film has a haze of less than 3% and complies with European regulations for use in food-contact packaging and labeling.

2. The film of claim 1, further comprising an adhesion promoter in the at least one printable coating.

3. The film of claim 2, wherein the adhesion promoter comprises acetoacetoxyethyl methacrylate.

4. The film of claim 3, wherein the acetoacetoxyethyl methacrylate comprises 1 to 5 weight percent of the at least one printable coating.

5. The film of claim 1, further comprising a primer layer adjacent to the at least one printable coating.

6. The film of claim 1, wherein ink is applied to the at least one printable coating, and the at least one printable coating has an ink adhesion of at least 80% when the ink is black.

7. The film of claim 1, wherein ink is applied to the at least one printable coating, and the at least one printable coating has an ink adhesion of at least 90% when the ink is cyan, yellow, magenta, or white.

8. The film of claim 1, further comprising an adhesive layer located on an outer surface of the multilayered film that is opposite to the at least one outer surface having the at least one printable coating.

9. The film of claim 1, further comprising an antiblock agent in the at least printable coating, whereby blocking values are less than 15 g/25 mm

10. The film of claim 1, wherein the film does not exhibit tearing when sheets are separated by hand.

11. The film of claim 1, wherein a roll of the film exhibits insignificant blocking when unwound at 400 m/min after one week of storage at 38° C. and 90% relative humidity.

12. The film of claim 1, wherein haze increases by 1% or less after placing the film in water at 80° C. for 30 minutes when the multilayered film is a transparent multilayered film.

13. The film of claim 1, wherein the core has a density within a range from 0.5 to 1.0 g/cm³.

14. The film of claim 1, further comprising the core or at least one tie layer in the multilayered film being a treated layer.

15. The film of claim 1, further comprising an antiblock agent in the at least one printable coating.

16. The film of claim 1, wherein the core is optionally transparent or white-opaque.

17. The film of claim 1, wherein the multilayered film comprises one or more tie layers.

18. The film of claim 1, wherein the multilayered film comprises one or more sealant layers.

19. The film of claim 1, wherein the multilayered film further comprises one or more additives in one or more layers of the multilayered film.

20. Use of the multilayered film of claim 1 in a packaging, tagging, bagging, or labeling application.
